(19) United States
(12) Patent Application Publication
(10) Pub. No.: US 2014/0161610 A1
(43) Pub. Date: Jun. 12, 2014

(54) METHOD AND DEVICE FOR REDUCING A PITCHING MOMENT WHICH LOADS A ROTOR OF A WIND POWER PLANT

(71) Applicant: Robert Bosch GmbH, Stuttgart (DE)

(72) Inventors: Felix Hess, Ludwigsburg (DE); Stefan Kapp, Ludwigsburg (DE)

(73) Assignee: Robert Bosch GmbH, Stuttgart (DE)

(21) Appl. No.: 14/102,022

(22) Filed: Dec. 10, 2013

(30) Foreign Application Priority Data
Dec. 12, 2012 (DE) 10 2012 024 272.7

(51) Int. Cl. F03D 7/02

(52) U.S. Cl. CPC F03D 7/0224
USPC 416/1; 416/9

(57) ABSTRACT

A method for reducing a pitching moment that loads a rotor of a wind power plant includes determining a manipulated variable in order to set an azimuth angle of the wind power plant. A horizontal oblique incoming flow against the rotor is brought about by a wind acting on the rotor by use of the azimuth angle so as to reduce a portion of the pitching moment that is caused by vertical wind shear acting on the wind power plant.

This application claims priority under 35 U.S.C. §119 to patent application no. DE 10 2012 024 272.7 filed on Dec. 12, 2012 in Germany, the disclosure of which is incorporated herein by reference in its entirety.

### BACKGROUND

The present disclosure relates to a method and to a device for reducing a pitching moment which loads a rotor of a wind power plant.

Modem wind power plants (WPP) with a horizontal axis have an azimuth adjustment system which orients the plane of the rotors of the wind power plants about their vertical axis.

In this context, the perpendicular orientation of the rotor plane with respect to the average direction of the wind is aimed at in order to maximize the energy yield in the partial load range of the wind power plant and minimize the asymmetrical loads on the rotor in the full load range.

The object of the present disclosure is to provide an improved method and an improved device for reducing a pitching moment which loads a rotor of a wind power plant.

### SUMMARY

This object is achieved by a method and a device for reducing a pitching moment which loads a rotor of a wind power plant, according to the disclosure.

Vertical wind shear acting on the rotor of a wind power plant brings about a pitching moment on the rotor. This pitching moment can be reduced or compensated by a horizontal oblique incoming flow against the rotor. As a result, an overall load acting on the wind power plant can be reduced. The oblique incoming flow can be achieved by adjusting the azimuth angle of the wind power plant.

One advantage of such adjustment of the azimuth angle is that in the case of stationary vertical shear the rotor can be rotated into a low-load position which reduces the use of IPC (individual pitch control) or the like for further load reduction, or makes IPC unnecessary.

A method for reducing a pitching moment which loads a rotor of a wind power plant comprises the following step:

determination of a manipulated variable in order to set an azimuth angle of the wind power plant, by means of which azimuth angle a horizontal oblique incoming flow against the rotor is brought about by wind acting on the rotor, in order to reduce a portion of the pitching moment which is caused by vertical wind shear acting on the wind power plant.

The wind power plant can be a wind power plant with a horizontal axis which has an azimuth adjustment system. The horizontal axis can run through a gondola of the wind power plant. A rotor of the wind power plant can be attached to a shaft running along the horizontal axis, said rotor having, for example, 2, 3 or more rotor blades arranged in a rotor plane. The azimuth angle of the wind power plant can be adjusted by means of the azimuth adjustment system, for example the gondola can be rotated about a vertical axis. Adjustment of the azimuth angle can bring about rotation of the rotor plane about the vertical axis. As a result the rotor can be oriented with respect to a wind direction of a wind acting on the rotor. A horizontal oblique incoming flow against the rotor can be understood as meaning that a horizontal portion of the wind which impacts on the rotor impacts obliquely that is to say at an angle with respect to the rotor plane which is not equal to 90°. By means of the manipulated variable the azimuth angle can therefore be set in such a way that the rotor is oriented obliquely with respect to the horizontal portion of the wind. The manipulated variable can represent the azimuth angle. In this way, an optimum azimuth angle can be set. Alternatively, the manipulated variable can also constitute a control variable for a control process for setting the azimuth angle. The manipulated variable can be an input variable of the azimuth adjustment system. Closed-loop or open-loop control of the setting of the azimuth angle can be carried out by means of the manipulated variable. A vertical wind shear influence, affecting the total load of the wind power plant, of the wind acting on the rotor can be reduced by setting the azimuth angle in accordance with the manipulated variable. A vertical wind shear can be understood as meaning that the horizontal portion of the wind which acts on the rotor has different wind speeds at different heights. For example, at a relatively low height, for example, in an area of the rotor near to the ground, the wind may have a lower wind speed than at a relatively high height, for example in an area of the rotor far from the ground. If a wind which impacts on the rotor plane perpendicularly has a vertical wind shear, this vertical wind shear can apply a pitching moment to the rotor. This pitching moment can be reduced by orienting the rotor plane obliquely with respect to the wind which impacts on the rotor plane, as a result of which a horizontal oblique incoming flow is produced. The horizontal oblique incoming flow can also bring about a pitching moment on the rotor which can counteract the pitching moment caused by the vertical wind shear. The manipulated variable can be determined by using one or more sensor signals. For example, it is possible to use a sensor signal which represents a load measured at the wind power plant. Additionally or alternatively, it is possible to use a sensor signal which represents a characteristic of the wind acting on the rotor, for example the vertical wind shear.

In the determination step, the manipulated variable can be determined in such a way that the portion of the pitching moment which is caused by the vertical wind shear is reduced by a portion of the pitching moment which is caused by the horizontal oblique incoming flow. As a result, the portion of the pitching moment which is caused by the vertical wind shear can be partially or completely compensated. For example, the portion of the pitching moment which is caused by the vertical wind shear and the portion of the pitching moment which is caused by the horizontal oblique incoming flow can be determined, assumed or estimated using suitable sensor signals, and the manipulated variable can be set in such a way that the portions of the pitching moment compensate one another. The manipulated variable can also be set in such a way that the pitching moment which results from the specified portions of the pitching moment is minimized.

The method can comprise a step of reading in a signal which represents a variable which brings about the pitching moment or a variable which is influenced by the pitching moment. In this context, in the determination step the manipulated variable can be determined using the signal. In this context, the pitching moment is understood to mean the pitching moment which loads the rotor of the wind power plant in total or the portion of the pitching moment which is caused by the vertical wind shear. A variable which brings about the pitching moment can be understood to be, for example, a wind distribution of the wind acting on the rotor, by means of which distribution the pitching moment can be determined by, for example, a calculation or estimation. A variable which is influenced by the pitching moment can be understood to be a variable which is measured on the rotor or on the wind power plant. As a result, the pitching moment can be detected very precisely. The manipulated variable can also be determined using a plurality of signals, for example using at least one signal which represents a variable which brings about the pitching moment and using at least one further signal which represents a variable which is influenced by the pitching moment. By using a plurality of signals to determine the manipulated variable it is possible to obtain this manipulated variable very precisely.

The method can comprise a step of detecting the signal using a sensor. The sensor can be part of the wind power plant or can be arranged on the wind power plant. Alternatively, the sensor can be arranged at a distance from the wind power plant. It is also possible to use a plurality of sensors to detect a plurality of signals which are used to determine the manipulated variable. For example, a sensor which is already used in any case on a wind power plant can also be used.

In addition, the method can comprise a step of setting the azimuth angle using the manipulated variable. The setting step can be carried out using a known azimuth adjustment system. Such an azimuth adjustment system can comprise an azimuth adjustment device which comprises, for example, a plurality of electric drives on the azimuth bearing.

For example, the signal can represent a signal made available by a strain sensor arranged on a blade root of a rotor blade of the rotor, a signal made available by an acceleration sensor arranged on the rotor, a signal made available by a fiber-Bragg sensor, a signal made available by a distance sensor, a signal made available by an eddy current sensor, a signal made available by a wind measuring mast or a signal made available by a radiation-based anemometer. It is also possible to use a plurality of sensors, and also different sensors from those mentioned.

In this context there can advantageously be recourse to a sensor system which is typically provided in any case in a wind power plant.

In the determination step, the manipulated variable can be determined by carrying out an open-loop control method or by carrying out a closed-loop control method. The open-loop control method can be carried out, for example, by using a predetermined relationship between the variable represented by the signal and the manipulated variable. The predetermined relationship can be stored in the form of a characteristic curve or a lookup table in a memory. The predetermined relationship may have been determined on the basis of preceding measurement series. In the case of a closed-loop control method, the manipulated variable may be set, for example, as a function of the pitching moment. In this way it is possible for the pitching moment to be reduced independently of preceding measurement series and for the dynamics of the adjustment to be predefined.

In the determination step, the manipulated variable of the wind power plant can be determined for a partial load operating mode of the wind power plant in such a way that a power level of the wind power plant is maximized. In contrast, for a full load operating mode of the wind power plant the manipulated variable can be determined in such a way that loading of the wind power plant is minimized Irrespective of whether the wind power plant is operated in the partial load operating mode or in the full load operating mode, a signal which represents the power level which is made available by the wind power plant or a signal which represents the loading of the wind power plant can be included in the determination of the manipulated variable. In this way, on the one hand the power level which can be made available is optimized and, on the other hand, the loading of the wind power plant can be kept low. The loading can be understood to be loading which is caused by the pitching moment acting on the rotor. In order to optimize the power level it may be appropriate to orient the rotor plane as perpendicularly as possible with respect to the main wind direction. In contrast, in order to minimize the loading it may be appropriate to orient the rotor plane obliquely with respect to the main wind direction.

In the determination step, the manipulated variable can be determined by using a value which represents the main wind direction of the wind, a speed of the wind, a power level of the wind power plant and/or a pitch angle of a rotor blade of the wind power plant. For example, the wind direction can be measured by means of a wind vane or an ultrasonic anemometer in the vicinity of the hub height on the gondola behind the rotor. For example, for this purpose it is possible to provide a signal processing device and a control system which averages measured wind directions, for example over 3 mins or 10 mins since the last azimuth adjustment. By using such values it is possible to ensure that components of the wind power plant are not loaded by high azimuth adjustment activity or that the frequency of the adjustment activity is similar to that of a wind power plant without the load reduction method according to the disclosure.

The device for reducing a pitching moment which loads a rotor of a wind power plant comprises the following feature:

a device for determining a manipulated variable in order to set an azimuth angle of the wind power plant, by means of which azimuth angle a horizontal oblique incoming flow against the rotor is brought about by a wind acting on the rotor, in order to reduce a portion of the pitching moment which is caused by vertical wind shear acting on the wind power plant.

A significant advantage of an azimuth control strategy which is based on such an approach is that the method minimizes the loading in the full load operating range even in the case of a nonhomogenous incoming flow.

In particular, the method minimizes the loads on the rotor even in the case of frequently occurring vertical shear. A further significant advantage is that open-loop or closed-loop control is at least not exclusively dependent only on a wind measurement at a point behind the rotor plane. This is important since the yield and the loading of the wind power plant arise from the air passing over the rotor over the entirety of the area of the rotor which can experience a nonhomogenous incoming flow.

The described approach can be used in combination or instead of methods which reduce the cyclical loading on the rotor blades, and as a result of which, inter alia, the loading on the main shaft, on the main bearing, on the tower head and on the foot of the tower can, under certain circumstances, also be reduced. Such methods are based on the measurement of the loads, for example by means of strain gauges on the blade roots, and the individual adjustment of the rotor blade angles during a rotation of the blades (individual pitch control, IPC).

The described approach can also be used in combination or instead of methods in which the local incoming flow against the rotor blade is measured, for example by means of pilot probes, and a change in the blade aerodynamics and therefore a reduction in the loading on each individual blade is caused by a local flow influence at the rotor blade by folding down, as a result of which, for example, a constant pitching moment on the rotor can be compensated.

One advantage of the described approach is that in the case of a nonhomogenous incoming flow such as vertical shear the actuators, for example the pitch drives do not have to perform at least one sinusoidal adjustment at every rotation of the rotor, in contrast to known methods. Therefore, the actuator and possibly the pitch bearing can be made simpler and there is no need for a complex device, which is possibly susceptible to faults, in the rotor blade for influencing the flow.

The described approach permits an extended azimuth control for wind power plants in order to optimize energy and reduce loading. The approach differs from the azimuth control systems for wind power plants in which the gondola is “turned into the wind”, i.e. an oblique incoming flow is measured and the gondola is tracked so as, where possible, to completely reduce the oblique incoming flow. Instead, in addition to the oblique incoming flow it is also possible to measure a vertical wind shear. This can be done, for example, by bending the blade in the impact direction. The vertical wind shear can be compensated by rotating the gondola. In this context, the gondola can then be at a slight incorrect angle with respect to the actual direction of the wind.

### BRIEF DESCRIPTION OF THE DRAWINGS

The disclosure will be explained in more detail below by way of example using the appended drawings, in which:

FIG. 1 shows a schematic plan view of a wind power plant;

FIG. 2 shows a schematic illustration of a wind power plant;

FIG. 3 shows a side view of a wind power plant;

FIG. 4 shows a side view of a wind power plant; and

FIG. 5 shows a flowchart of a method for reducing a pitching moment which loads a rotor of a wind power plant.

### DETAILED DESCRIPTION

Identical or similar elements in the following figures can be provided by identical or similar reference symbols. In addition, the figures of the drawings, the description thereof and the claims contain numerous features in combination. It is clear to a person skilled in the art here that these features can also be considered individually or combined to form further combinations which are not described here explicitly.

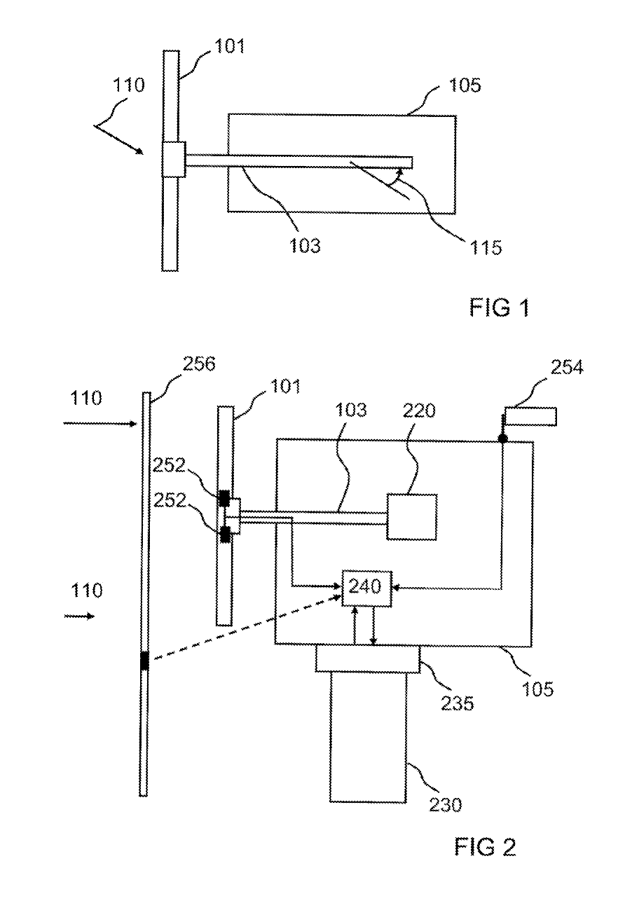

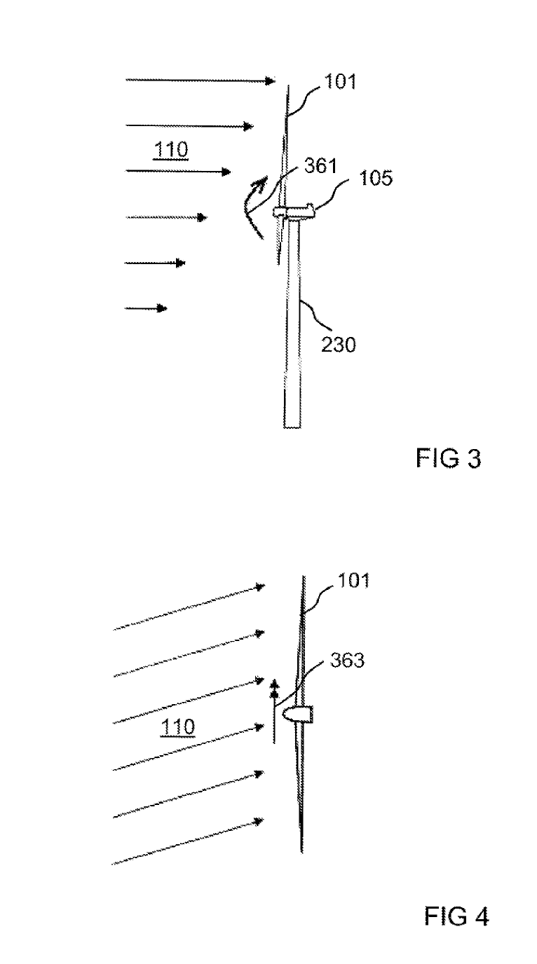

FIG. 1 shows a schematic plan view of a wind power plant according to one exemplary embodiment of the disclosure. A rotor 101, which is rotatably mounted in a gondola 105 by means of a horizontally arranged rotor shaft 103 is shown. The rotor 101 can have, for example, three rotor blades, two rotor blades of which are shown in FIG. 1 by way of example. In FIG. 1, a horizontal portion of a wind 110 acting on the rotor 101 is shown by means of an arrow. The rotor 101 is caused to rotate or kept rotating by the wind 110. The wind 110 has a vertical shear such as is shown below by means of FIG. 3. The vertical shear applies a pitching moment to the rotor 101. In order to reduce the pitching moment caused by the vertical shear, an azimuth angle 115 of the wind power plant is set in such a way that a horizontal oblique incoming flow of the rotor 101 occurs as a result of the wind 110. The azimuth angle 115 defines a rotation of the rotor plane of the rotor 101 or a rotation of the gondola 105 about a vertical axis. Owing to the azimuth angle 115 which is set, a rotor plane or rotor face of the rotor 101 can therefore be oriented obliquely with respect to the horizontal portion of the wind 110 which is shown in FIG. 2. As a result of the oblique incoming flow against the rotor 101, a further pitching moment is applied to the rotor 101. The azimuth angle 115 is selected such that the pitching moment caused by the oblique incoming flow against the rotor 101 counteracts the pitching moment caused by the vertical shear.

If the wind power plant is operated in a first operating mode, for example in the full load operating mode, the azimuth angle 115 can, according to one exemplary embodiment, be set in such a way that the pitching moment caused by the vertical shear is, where possible, compensated completely by the pitching moment caused by the oblique incoming flow against the rotor 101. In the first operating mode, the loading of the wind power plant which is caused by the wind 110 can therefore be minimized or be kept for example below a predefined maximum loading.

If the wind power plant is operated in a second operating mode, for example in the partial load operating mode, the azimuth angle 115 can, according to one exemplary embodiment, be set in such a way that the pitching moment caused by the vertical shear is not compensated, or is only compensated proportionally, by the pitching moment caused by the oblique incoming flow against the rotor 101. As a result, in the second operating mode the power level which is output by the wind power plant can be optimized.

FIG. 2 shows a schematic illustration of a wind power plant according to an exemplary embodiment of the disclosure. This can be the wind power plant described with reference to FIG. 1. The wind power plant has a rotor 101 which is rotatably mounted in a gondola 105 by means of a rotor shaft 103. A generator 220 is arranged in the gondola 105 and can be driven via the rotor shaft 105, directly or via a gear mechanism. The rotational movement of the rotor shaft 105 can be used to generate electrical energy by means of the generator 220.

Wind 110 acts on the rotor 101, as indicated by arrows. Even if it is not apparent from FIG. 2, a horizontal portion of the wind 110 impacts obliquely on the rotor 101 as shown in FIG. 1. It is apparent in FIG. 2 that the wind 110 has a vertical shear. Here, the wind 110 has a lower speed in a lower region of the rotor 110 than in an upper region of the rotor 110.

The gondola 105 is rotatably arranged on a tower 230. The wind power plant has an azimuth drive 235 by means of which an azimuth angle of the wind power plant can be set. The azimuth drive 235 is designed to rotate the gondola 105 about a vertical axis, here, for example, a longitudinal axis of the tower 230. According to this exemplary embodiment, the azimuth angle is set by the azimuth drive 235 in such a way that the gondola 105 is oriented with respect to the wind 110 in such a way that the rotor 101 is not set directly into the wind 110. This results in a horizontal oblique incoming flow against the rotor 101.

The wind power plant has a device 240 for reducing a pitching moment which loads the rotor 101. The device 240 is designed to determine a manipulated variable in order to set the azimuth angle of the wind power plant and to make it available to the azimuth drive 235 via an interface. The azimuth drive 235 is designed to set the azimuth angle on the basis of the manipulated variable. The device 240 has a further interface for receiving at least one signal which represents a variable by means of which a portion of the pitching moment acting on the rotor 101 is brought about or which is influenced by at least a portion of the pitching moment. The device 240 is designed to determine the manipulated variable using the at least one signal. The at least one signal can be made available by a sensor. For example, the signal can represent a variable which characterizes the wind 110. In addition, the signal can represent a variable characterizing loading of the wind power plant, for example loading which brings about a pitching moment acting on the rotor 101.

Merely by way of example a number of possible signals which can be used by the device 240 to determine the manipulated variable for the azimuth angle are described below with reference to FIG. 2.

If the wind power plant has strain gauges on the blade roots of the rotor blades of the rotor 101, the signal can represent flexural loading of the rotor blades on the blade roots. Such a signal represents a variable which is brought about by a pitching moment acting on the rotor 101.

If the wind power plant has a wind vane 254 which is arranged for example on the lee side of the gondola 105, the signal can represent a wind direction of the wind 110 which is detected by the wind vane 254.

If, for example, a wind mast 256 for detecting the wind 110 before it impacts on the rotor 101 is arranged on the windward side in front of the wind power plant, the signal can represent a variable, detected by the wind mast 256, relating to the wind 110, for example a wind direction, a wind speed or a wind distribution. The wind mast 256 can have a multiplicity of sensors for detecting a wind direction, additionally or alternatively for detecting a wind speed. Such sensors can be arranged, for example, distributed over a section of the wind mast 256 which is located in the region of the rotor 101.

The wind mast 256 can have a transmitting device for wireless or wire-bound transmission of the signal to the device 240.

FIG. 3 shows a side view of a wind power plant according to an exemplary embodiment of the disclosure. This can be the wind power plant described with reference to FIG. 1. The wind 110 which impacts on the rotor 101 has a vertical shear. Given the vertical shear shown, a positive pitching moment 361 impacts on the rotor 101. An upper region of the rotor 101 is forced in the direction of the gondola 105 by the pitching moment 361. A lower region of the rotor 101 is, in contrast, forced away from the tower 230.

FIG. 4 shows a plan view of a wind power plant according to an exemplary embodiment of the disclosure. This can be the wind power plant described with reference to FIG. 1. There is an oblique incoming flow against the rotor 101 by the wind 110 impacting on the rotor 101, with the result that there is a horizontal oblique incoming flow against the rotor 101. Owing to the horizontal oblique incoming flow, a positive pitching moment 363 impacts on the rotor 101. As a result of the pitching moment 363, an upper region of the rotor 101 is forced in the direction of the gondola 105. A lower region of the rotor 101 is, in contrast, forced away from the tower 230. The pitching moment 363 which is caused by the horizontal oblique incoming flow is therefore in the same direction as the pitching moment caused by the vertical shear and shown with reference to FIG. 3.

If the azimuth angle of the wind power plant shown in FIG. 4 is set in such a way that a rotational axis of the rotor is rotated by the wind 110, with the result that the wind 110 flows obliquely against the front side of the rotor 101, coming from the other side, a negative pitching moment is caused which is opposed to the direction of the pitching moment 363 shown and is therefore suitable for compensating the pitching moment which is caused by the vertical shear and is shown in FIG. 3.

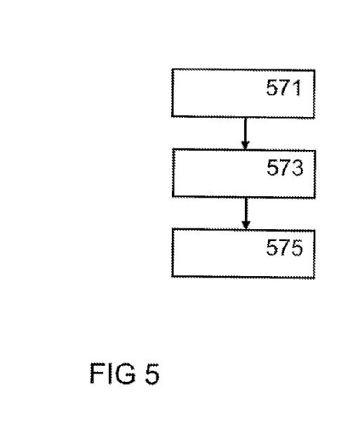

FIG. 5 shows a flowchart of a method for reducing a pitching moment which loads a rotor of a wind power plant, according to an exemplary embodiment of the present disclosure. Steps of the method may be implemented, for example, by suitable apparatuses of the device shown in FIG. 2 for reducing a pitching moment which loads a rotor of a wind power plant. By carrying out the steps of the method it is possible to reduce the loading of the wind power plant during operation of the wind power plant.

In a step 571, a signal, for example of a sensor arranged on or in the vicinity of the wind power plant, can be read in. In a step 571, a manipulated variable for setting an azimuth angle of the wind power plant is determined using the signal. The manipulated variable is determined here in such a way that a horizontal oblique incoming flow against the rotor is brought about. A degree of the oblique incoming flow is selected here in such a way that a portion of the pitching moment which is caused by a vertical shear is reduced. In a step 575, the determined manipulated variable is made available, for example to an azimuth drive 235 for setting the azimuth angle.

According to one exemplary embodiment, the manipulated variable can be determined in the step 573 as a function of an operating mode of the wind power plant or as a function of a current loading of the wind power plant. It is therefore possible that, for example in the partial load operating mode of the wind power plant or for as long as a maximum permissible loading of the wind power plant is not yet reached, the manipulated variable is determined in such a way that the rotor 101 does not experience an oblique incoming flow, or only experiences a small oblique incoming flow, with the result that the pitching moment caused by the vertical shear is not reduced, or is only reduced slightly, but on the other hand the power level which can be made available by the wind power plant can be maximized.

The exemplary embodiments of the present disclosure will be described in more detail below with reference to the preceding figures.

An exemplary embodiment of the present disclosure comprises an azimuth adjustment of the wind power plant which both maximizes the energy yield in the partial load range and reduces the loading at the rotor blade and the consequent loading thereof in the case of vertical shear.

In this context, load data of the rotor 101 can be used. Such load data is more informative about the advantageousness of the orientation of the rotor 101 in the wind 110 than the wind measuring devices 254 and the gondola 105 behind the rotor 101. The load data on the rotor 101 reflect the effect of the wind 110, averaged over the rotor surface, on the wind power plant, while the gondola-based measurement is only influenced in a punctiform fashion and by the rotor movement. As a result, the objectives of maximizing energy and reducing loading are achieved better than with a conventional sensor system.

According to one exemplary embodiment of the disclosure, an azimuth control is carried out for a wind power plant on the basis of sensor data which permit the rotor pitching moment 361, 363 to be inferred.

For this purpose it is possible to use strain sensors 252 on the blade roots as well as in an IPC control. Alternatively it is possible to use acceleration sensors, fiber-Bragg sensors or a laser distance sensor system for determining the loading of the blades. The loading of the blade roots can also be determined from the relative movement of the hub with respect to the gondola 105, which can be measured, for example, by means of eddy current sensors.

Furthermore, the direct measurement of the vertical wind shear in front of the wind power plant and the horizontal oblique incoming flow, for example by means of a measuring mast 256 or vertical or horizontal lidar anemometer, can be used as sensor information which can be included as a signal, for example, in a device 240 for reducing a pitching moment 361, 363 which loads a rotor 101 of a wind power plant. A corresponding anemometer can be arranged on the wind power plant or in the surroundings of the wind power plant. Measured values for the vertical wind shear and the horizontal oblique incoming flow can be used to infer the resulting pitching moment at the rotor and to determine the manipulated variable for setting the azimuth angle 115.

According to one exemplary embodiment, the pitching moment 361, 363 at the rotor 101 is firstly measured, for example, by means of strain measurement in the impacting direction on at least one rotor blade, preferably on all the rotor blades. For example sensors 252, such as are illustrated schematically in FIG. 2, can be used for this. The measurement signals which are obtained from the measurement are fed to a control unit for processing the measurement signals and outputting a setpoint azimuth angle. The control unit can be the device 240 shown in FIG. 2, said device being designed in this exemplary embodiment to output, as a manipulated variable, the setpoint azimuth angle 115 to the azimuth drive 235. The azimuth drive 235 is embodied, for example, in the form of an azimuth adjustment unit in order to set the wind power plant to the predefined setpoint azimuth angle 115.

According to one exemplary embodiment, the setpoint azimuth angle 115, that is to say the optimum adjustment angle, is stored statically in the form of a characteristic curve in a control device, with the result that the new azimuth angle 115 is set as part of a pure open-loop control processor. Alternatively, a movement angle for setting the new azimuth angle 115 can be adjusted proportionally or in an integral-proportional fashion with respect to the pitching moment 361, 363, and can therefore be closed-loop controlled.

In the case of a pure open-loop control process, a signal which represents the pitching moment 361, 363, for example in the form of a pitching moment signal, can firstly be averaged over a time interval and the open-loop control process can firstly be carried out when a threshold value is exceeded or undershot. Instead of averaging, further forms of low-pass filtering, median value calculation or the like are also possible.

According to one exemplary embodiment, an optimum adjustment angle for setting a new azimuth angle 115 is determined as a manipulated variable, said optimum adjustment angle constituting in the partial load range an azimuth angle 115 which produces the maximum power level of the wind power plant. In the full load range the adjustment angle which causes an azimuth angle 115 to be set which brings about the lowest loads on the system is determined as the manipulated variable.

According to one exemplary embodiment of the method for reducing a pitching moment which loads a rotor of a wind power plant, further measurement variables such as, for example, the wind direction which is determined by the wind vane 254 on the gondola 105, the current wind speed, the power level of the wind power plant and the pitch angle can be used. The sensor data can then be fused by means of a Kalman filter in order to determine the wind direction. Compared to calculation by means of a characteristic curve, the measurement variable is therefore further improved.

According to one exemplary embodiment the device 240 shown in FIG. 2 is an azimuth control unit into which signals of sensor data for the pitching moment 361, 363 are input and which gives rise to an azimuth closed-loop control strategy which, given vertical wind shear without an oblique incoming flow, gives rise to an oblique position of the rotor plane with respect to the wind direction.

The exemplary embodiments shown are selected only by way of example and can be combined with one another.

### LIST OF REFERENCE NUMBERS

101 Rotor
103 Rotor shaft
105 Gondola
110 Wind
115 Azimuth angle
220 Generator (possibly with gear mechanism upstream of the generator)
230 Tower
235 Azimuth drive
240 Device
252 Strain sensors
254 Wind vane
256 Mast
361 Pitching moment
363 Pitching moment

What is claimed is:

1. A method for reducing a pitching moment that loads a rotor of a wind power plant, comprising:
determining a manipulated variable in order to set an azimuth angle of the wind power plant,
wherein, by use of the azimuth angle, a horizontal oblique incoming flow against the rotor is brought about by a wind acting on the rotor so as to reduce a portion of the pitching moment caused by vertical wind shear acting on the wind power plant.

2. The method according to claim 1, wherein the manipulated variable is determined in such a way that the portion of the pitching moment caused by the vertical wind shear is reduced by a portion of the pitching moment caused by the horizontal oblique incoming flow.

3. The method according to claim 1, further comprising reading in a signal that represents a variable that brings about the pitching moment or a variable that is influenced by the pitching moment, wherein the manipulated variable is determined using the signal.

4. The method according to claim 3, further comprising detecting the signal using a sensor and setting the azimuth angle using the manipulated variable.

5. The method according to claim 3, wherein the signal represents a signal generated by a strain sensor arranged on a blade root of a rotor blade of the rotor, a signal generated by an acceleration sensor arranged on the rotor, a signal generated by a fiber-Bragg sensor, a signal generated by a distance sensor, a signal generated by an eddy current sensor, a signal generated by a wind measuring mast, or a signal generated by a radiation-based anemometer.

6. The method according to claim 1, wherein the manipulated variable is determined by carrying out an open-loop control method or by carrying out a closed-loop control method.

7. The method according to claim 1, wherein the manipulated variable of the wind power plant is determined for (i) a partial load operating mode of the wind power plant in such a way that a power level of the wind power plant is maximized and (ii) a full load operating mode of the wind power plant in such a way that loading of the wind power plant is minimized.

8. The method according to claim 1, wherein the manipulated variable is determined by using a value which represents one or more of the main wind direction of the wind, a speed of the wind, a power level of the wind power plant, and a pitch angle of a rotor blade of the wind power plant.

9. A device for reducing a pitching moment that loads a rotor of a wind power plant, comprising:
a device configured to determine a manipulated variable in order to set an azimuth angle of the wind power plant,
wherein, by use of the azimuth angle, a horizontal oblique incoming flow against the rotor is brought about by a wind acting on the rotor so as to reduce a portion of the pitching moment caused by vertical wind shear acting on the wind power plant.

10. A computer program product with program code for reducing a pitching moment that loads a rotor of a wind power plant when the program product is executed on a device, the device including:
a device configured to determine a manipulated variable in order to set an azimuth angle of the wind power plant,
wherein, by use of the azimuth angle, a horizontal oblique incoming flow against the rotor is brought about by a wind acting on the rotor so as to reduce a portion of the pitching moment caused by vertical wind shear acting on the wind power plant.
